(19) United States
(12) Patent Application Publication
(10) Pub. No.: US 2019/0120945 A1
(43) Pub. Date: Apr. 25, 2019

(54) LASER RANGEFINDER AND METHOD FOR IMPLEMENTING THE SAME

(71) Applicant: Fangyi Cai, Nanchang City (CN)

(72) Inventor: Fangyi Cai, Nanchang City (CN)

(21) Appl. No.: 15/791,382

(22) Filed: Oct. 23, 2017

(51) Int. Cl. G01S 7/486; G01S 17/10; G01S 7/51

(52) U.S. Cl. CPC G01S 7/4865; G01S 7/51; G01S 7/4868; G01S 17/107

(57) ABSTRACT

A laser rangefinder and a method for implementing the same are provided. When the distance is measured, a number of laser pulses are emitted from a transmitting unit to an object to be measured. A receiving unit receives the laser pulses reflected by the measured object and converts them into an electrical pulse signal. A time measuring unit converts a control signal of a laser emitting module and the electric pulse signal converted by the laser receiving module into a rectangular gate signal. The width of the rectangular gate signal is measured by a pulse counter unit with high precision.

### BACKGROUND OF THE INVENTION

### 1. Field of the Invention

The present invention relates to a laser rangefinder, and more particularly to a laser rangefinder and a method for implementing the same.

### 2. Description of the Prior Art

A laser rangefinder is an instrument that uses the laser to accurately measure the distance of the object. The laser rangefinder emits a very fine laser beam to the object during operation and receives the laser beam reflected by the object through a photoelectric element. A time measuring device measures the time of the laser beam from emitting to receiving for calculating the distance from the observer to the object.

There are various laser rangefinders on the markets, and there are various methods for implementing the ranging.

As disclosed in Chinese Patent application number 201210291997.1, the measurement principle uses the time expansion method which is used in most of the distance measurements. The laser transmission time is linearly amplified N times, and then a pulse generated by a lower frequency crystal oscillator is counted after the expansion time for calculating the distance from the measured point to the object.

As disclosed in Chinese Patent application number 201610494652.4, a direct counting method is used to implement a rough distance measurement, and a mixing frequency technology is used to implement a precise distance measurement.

Chinese Patent application number 201610890733.6 discloses a laser ranging method based on mode-locked pulse series. The transmission times of a measuring beam and a reference beam are measured, respectively. A rough distance measurement value is obtained by calculating the pulse difference. A precise value is obtained by measuring the phase difference of the two beams to obtain the distance from the ranging point to the object.

Although the above products can achieve the purpose of ranging, the measuring speed is slow, the response time is long, and the precision of measurement is low.

### SUMMARY OF THE INVENTION

In view of the shortcomings of the prior art, the primary object of the present invention is to provide a laser rangefinder and a method for implementing the same, which provide not only a fast measurement but also a high accuracy, thereby overcoming the deficiencies of the prior art.

According to one aspect of the present invention, a laser rangefinder is provided. The laser rangefinder comprises a transmitting unit, a receiving unit, a time measuring unit, a data processing and control unit, an angle measuring module, a display module, a power supply control module, and a button. The transmitting unit includes a high voltage power supply module and a laser emitting module connected with the high voltage power supply module.

The receiving unit includes a laser receiving module, a signal amplifying module, and a shaping circuit module. The laser receiving module is electrically connected with the signal amplifying module. The signal amplifying module is electrically connected with the shaping circuit module.

The time measuring unit includes a phase-locked loop module, an I2C module connected with the phase-locked loop module, a counter unit, and a gate signal module. An output end of the shaping circuit module is connected with the gate signal module. The gate signal module has one output end connected with the high voltage power supply module and another output end connected with the counter unit. An output end of the counter unit is connected with the I2C module. The counter unit is composed of four independent pulse counters. The phase-locked loop module has a frequency multiplication/division and phase shift function module for synchronously generating clock signals of different frequencies and phases to the respective counters;

The data processing and control unit includes a microprocessor. The microprocessor is connected with an output end of the I2C module.

The angle measuring module is connected with the microprocessor.

The display module is connected with the microprocessor.

One end of the power supply control module is connected with the microprocessor. The power supply control module has three output ends connected with the transmitting unit, the receiving unit, and the time measuring unit, respectively.

The button is connected with the microprocessor. An output end of the microprocessor is connected with the time measuring unit.

Preferably, the display module is a liquid crystal display.

According to one aspect of the present invention, a method for implementing the aforesaid laser rangefinder is provided. The method comprises the following steps of:
a. the laser rangefinder being used to aim at an object to be measured, the button being pressed to start measuring;
b. the microprocessor responding to the key in real time, the power supply control module energizing the transmitting unit, the receiving unit and the time measuring unit;
c. the microprocessor sending a trigger signal to the time measuring unit;
d. the time measuring unit receiving the trigger signal and simultaneously sending a synchronous trigger signal through the gate signal module, the synchronous trigger signal controlling the laser emitting module to emit a laser beam, the synchronous trigger signal simultaneously triggering the counter unit to start counting;
e. the laser receiving module receiving the laser beam reflected by the measured object, the laser beam being amplified and shaped by the signal amplifying module and the shaping circuit module, an end pulse being fed back to the gate signal module of the time measuring unit, the gate signal module sending the end pulse to the counter unit for terminating the count immediately;
in the process, a start signal provided by the microprocessor being converted into a falling edge of the gate signal after synchronization, the end pulse after shaped by the receiving unit being converted into a rising edge of the gate signal to form a negative rectangular gate signal, a signal generated by an external high frequency crystal oscillator being performed for frequency multiplication and phase shift by the phase-locked loop module to generate a multiplex high frequency signal as a clock signal of the counter unit, upper and lower edges of the rectangular gate signal being measured by the independent pulse counters respectively; a rising edge of the end pulse being counted by an edge termination counter unit;
f. an integrated count result N of the counter unit being transmitted to the microprocessor through the I2C module;
g. the microprocessor receiving the integrated count result N of the counter unit, calculating a time value by the microprocessor, reading the information of an acceleration sensor in the angle measuring module, and ending a measurement;
the time being calculated by the microprocessor: time t=N*T0/8, a distance between a ranging point and the measured object D=C*t=C*N*T0/8, T0=1/3*10-8 s, C=3*108 m/s, that is, D=N/8.
h. the steps c-g being repeated several times;
i. regression and iterative algorithm being used to integrate a number of measurement results and calculate the distance and an inclination angle between the ranging point and the measured object;
after the microprocessor sends the trigger signal, acceleration three-dimensional component data, Ax, Ay, and AZ, being read from the acceleration sensor of the angle measuring module, the microprocessor calculating the inclination angle of the distance between the ranging point and the measured object;
j. the results being displayed through the display module.
Preferably, in step e, the crystal oscillator has a frequency of 50M.
Preferably, in step j, there are four display modes;
mode 1, only displaying the distance in meters;
mode 2, only displaying the distance in yards;
mode 3, displaying the distance and the angle of inclination in meters;
mode 4, displaying the distance and the angle of inclination in yards.

The present invention has obvious advantages and beneficial effects compared with the prior art. In particular, it is known from the above technical solution that the phase-locked loop module has the frequency multiplication/division and phase shift function module to generate multiple clock signals of different frequencies and phases to the respective counters. In the measurement method, the multi-channel phase-shift direct counting method is used. That is, the signal generated by the high frequency crystal oscillator is performed for frequency multiplication and phase shift by the phase-locked loop module to generate a multiplex high frequency signal as the clock signal of the counter unit (composed of a plurality of counters). The gate signal module converts the transmission time from the laser ranging point to the measured object into a rectangular gate signal, and the plurality of counters directly count the widths of the upper and lower edges of the rectangular gate signal to obtain an integrated count result N. The measurement time t is calculated by the formula in the microprocessor. The distance D between the ranging point and the measured object is calculated from the measurement time t. When this measurement method is used to measure the distance, only the upper and lower edges of the rectangular gate signal are counted and added with the subsequent processing to take the average, so that the final measurement result can be obtained fast and precisely. In addition, the angle measuring module can measure the angle between the emitted light beam and the horizontal plane. The regression and iterative algorithm are used to integrate several measurement results to calculate the distance and the inclination angle ψ between the ranging point and the measured object, so that the laser rangefinder of the present invention displays not only the measured distance but also the inclination angle. The function is more comprehensive.

### BRIEF DESCRIPTION OF THE DRAWINGS

FIG. 1 is a block diagram according to an embodiment of the present invention.

### DETAILED DESCRIPTION OF THE PREFERRED EMBODIMENTS

Embodiments of the present invention will now be described, by way of example only, with reference to the accompanying drawings.

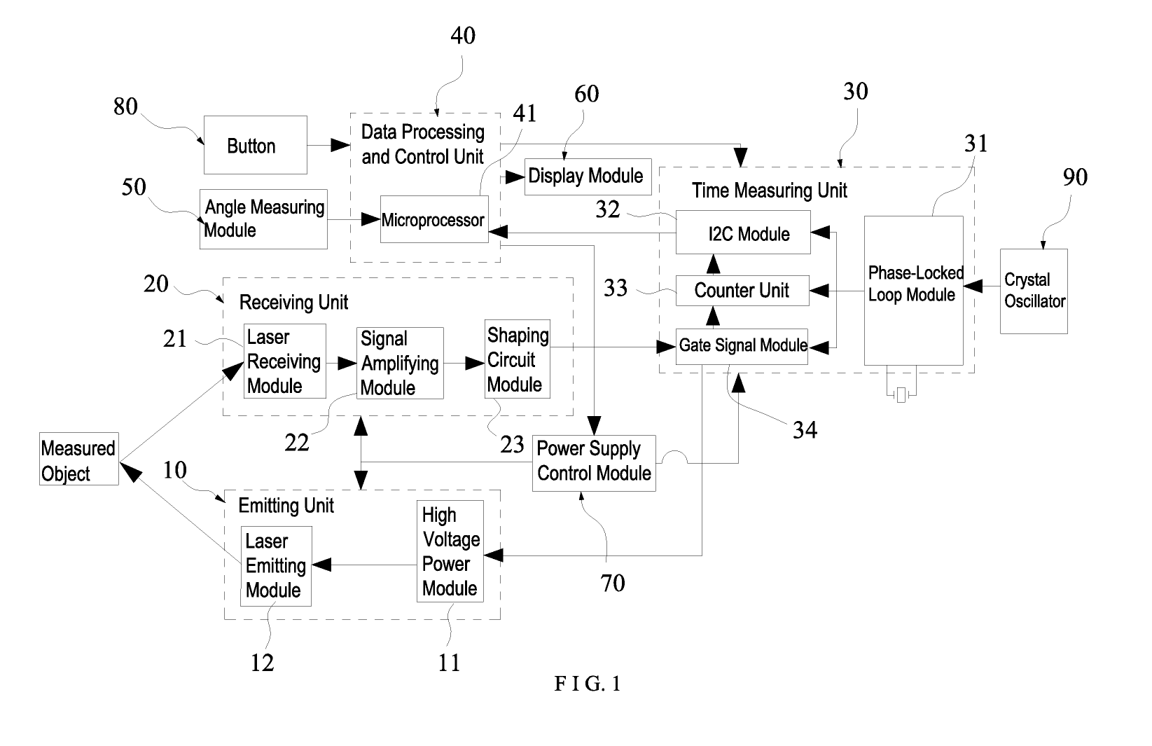

As shown in FIG. 1, a laser rangefinder in accordance to a preferred embodiment of the present invention comprises a transmitting unit 10, a receiving unit 20, a time measuring unit 30, a data processing and control unit 40, an angle measuring module 50, a display module 60, a power supply control module 70, and a button 80.

Wherein, the transmitting unit 10 includes a high voltage power supply module 11 and a laser emitting module 12 connected with the high voltage power supply module 11. The laser emitting module 12 has a laser emitting head, a lens, and the like. The high voltage power supply module 11 supplies a high voltage to the laser emitting head to emit a laser beam.

The receiving unit 20 includes a laser receiving module 21, a signal amplifying module 22, and a shaping circuit module 23. The laser receiving module 21 is electrically connected with the signal amplifying module 22. The signal amplifying module 22 is electrically connected with the shaping circuit module 23. The laser receiving module 21 is used for receiving a laser pulse reflected from an object to be measured and for converting the laser pulse into an electrical pulse signal. The signal amplifying module 22 amplifies the waveforms of the electrical pulse. The shaping circuit module 23 processes or transforms the distorted waveforms or different waveforms of the electrical pulse signal.

The time measuring unit 30 includes a phase-locked loop module 31, an I2C module 32 connected with the phase-locked loop module 31, a counter unit 33, and a gate signal module 34. An output end of the shaping circuit module 23 is connected with the gate signal module 34. The gate signal module 34 has one output end connected with the high voltage power supply module 11 and another output end connected with the counter unit 33. An output end of the counter unit 33 is connected with the I2C module 32. The gate signal module 34 converts the control signal of the laser emitting module 12 and the electrical pulse signal converted by the laser receiving module 21 into a rectangular gate signal. The I2C module 32 is used to connect a microprocessor and its peripheral devices to communicate with each other. The counter unit 33 is composed of a plurality of independent pulse counters.

In this embodiment, the number of the counters is four. The phase-locked loop module 31 has a frequency multiplication/division and phase shift function module, which can generate clock signals of different frequencies and phases (for example, five channels) to the respective counters. When in operation, the high precision pulse counter measures the width of the rectangular gate signal.

The data processing and control unit 40 includes a microprocessor 41. The microprocessor 41 is written with software to complete a series of functions, such as power control, signal triggering, calculation, comparison, and logic processing. The microprocessor 41 is connected with an output end of the I2C module 32 for receiving the count result of the counter and for directly calculating the received result.

The angle measuring module 50 includes an acceleration sensor. The angle measuring module 50 is connected with the microprocessor 41. The angle measuring module 50 measures the angle of inclination of the emitted laser beam and the horizontal plane.

The display module 60 is connected with the microprocessor 41 for displaying the measured distance value, angle, and the like.

The button 80 is connected with the microprocessor 41. One end of the power supply control module 70 is connected with the microprocessor 41. The power supply control module 70 has three output ends connected with the transmitting unit 10, the receiving unit 20, and the time measuring unit 30 respectively. An output end of the microprocessor 41 is connected with the time measuring unit 30. When the button 80 is pressed, the power supply control module 70 energizes the transmitting unit 10, the receiving unit 20 and the time measuring unit 30 and simultaneously sends a trigger signal to the time measuring unit 30 for counting at any time.

The working principle of the laser rangefinder of the present invention is as follows: When the distance is measured, the transmitting unit 10 emits a plurality of laser pulses to an object to be measured. The receiving unit 20 receives the laser pulses reflected by the measured object and converts them into an electric pulse signal. The time measuring unit 30 converts the control signal of the laser emitting module 12 and the electric pulse signal converted by the laser receiving module 21 into a rectangular gate signal. The width of the rectangular gate signal is measured by the high precision pulse counter unit 33. The angle measuring module 50 measures the angle of inclination of the emitted laser and the horizontal plane. The data processing and control unit 40 converts the measured time into a distance and displays the straight line distance and the angle of inclination between the ranging point and the object through the display module 60.

The method for implementing the laser rangefinder comprises the following steps:
a. The laser rangefinder is used to aim at an object to be measured, and the button 80 is pressed to start the measurement.
b. The microprocessor 41 responds to the key 80 in real time, the power supply control module 70 energizes the transmitting unit 10, the receiving unit 20, the time measuring unit 30.
c. The microprocessor 41 sends a trigger signal to the time measuring unit 30.
d. The time measuring unit 30 receives the trigger signal and simultaneously sends a synchronous trigger signal through the gate signal module 34, the synchronous trigger signal controls the laser emitting module 12 to emit a laser beam, the synchronous trigger signal simultaneously triggers the counter unit 33 to start counting.
e. The laser receiving module 21 receives the laser beam reflected by the measured object. After the laser beam is amplified and shaped by the signal amplifying module 22 and the shaping circuit module 23, an end pulse is fed back to the gate signal module 34 of the time measuring unit 30. The gate signal module 34 sends the end pulse to the counter unit 33 for terminating the count immediately.
In this process, the start signal provided by the microprocessor 41 is converted into the falling edge of the gate signal after synchronization. The end pulse is obtained by the receiving unit 20 after shaping. The gate signal module converts the end pulse signal into the rising edge of the gate signal, forming a negative rectangular gate signal. The signal generated by an external high frequency crystal oscillator 90 is performed for frequency multiplication and phase shift by the phase-locked loop module 31 to generate a multiplex high frequency signal as the clock signal of the counter unit 33. The upper and lower edges of the rectangular gate signal are measured by four independent pulse counters, respectively. The rising edge of the end pulse is counted by the edge termination counter unit 33. In this embodiment, the frequency of the crystal oscillator 90 is 50M.
f. The integrated count result N of the counter unit 33 is transmitted to the microprocessor 41 through the I2C module 32.
g. The microprocessor 41 receives the integrated count result N of the counter unit 33, calculates the time value by the microprocessor 41, reads the information of the acceleration sensor in the angle measuring module 50, and ends the measurement.
The time is calculated by the microprocessor 41: time t=N*T0/8.
The distance between the ranging point and the measured object D=C*t=C*N*T0/8, T0=1/3*10-8 s, C=3*108 m/s, that is, D=N/8.
h. The steps c-g are repeated several times.
i. The regression and iterative algorithm are used to integrate a number of measurement results, calculate the distance and the angle of inclination between the ranging point and the measured object.
After the microprocessor 41 sends the trigger signal, the acceleration three-dimensional component data, Ax, Ay, and AZ, is read from the acceleration sensor of the angle measuring module 50. The microprocessor 41 calculates the angle of inclination of the distance between the ranging point and the measured object.
j. The results are displayed through the display module. There are four display modes.
Mode 1, only displaying the distance in meters;
Mode 2, only displaying the distance in yards;
Mode 3, displaying the distance and the angle of inclination in meters;
Mode 4, displaying the distance and the angle of inclination in yards.

Accordingly, the features of the present invention are described below. Since the phase-locked loop module 31 has the frequency multiplication/division and phase shift function module to generate five clock signals of different frequencies and phases to the respective counters. In the measurement method, the multi-channel phase-shift direct counting method is used. That is, the signal generated by the high frequency crystal oscillator 90 is performed for frequency multiplication and phase shift by the phase-locked loop module 31 to generate a multiplex high frequency signal as the clock signal of the counter unit 33 (composed of a plurality of counters). The gate signal module 34 converts the transmission time from the laser ranging point to the measured object into a rectangular gate signal, and the plurality of counters directly count the widths of the upper and lower edges of the rectangular gate signal to obtain an integrated count result N. The measurement time t is calculated by the formula in the microprocessor 41. The distance between the ranging point and the measured object is calculated from the measurement time t. When this measurement method is used to measure the distance, only the upper and lower edges of the rectangular gate signal are counted and added with the subsequent processing to take the average, so that so that the final measurement result can be obtained fast and precisely. In addition, the angle measuring module 50 can measure the angle between the emitted light beam and the horizontal plane. The regression and iterative algorithm are used to integrate several measurement results to calculate the distance and the inclination angle Φ between the ranging point and the measured object, so that the laser rangefinder of the present invention displays not only the measured distance but also the inclination angle. The function is more comprehensive.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A laser rangefinder, comprising:
a transmitting unit, the transmitting unit including a high voltage power supply module and a laser emitting module connected with the high voltage power supply module;
a receiving unit, the receiving unit including a laser receiving module, a signal amplifying module and a shaping circuit module, the laser receiving module being electrically connected with the signal amplifying module, the signal amplifying module being electrically connected with the shaping circuit module;
a time measuring unit, the time measuring unit including a phase-locked loop module, an I2C module connected with the phase-locked loop module, a counter unit and a gate signal module; an output end of the shaping circuit module being connected with the gate signal module, the gate signal module having one output end connected with the high voltage power supply module and another output end connected with the counter unit, an output end of the counter unit being connected with the I2C module; the counter unit being composed of a plurality of independent pulse counters; the phase-locked loop module having a frequency multiplication/division and phase shift function module for synchronously generating clock signals of different frequencies and phases to the respective counters;
a data processing and control unit, the data processing and control unit including a microprocessor, the microprocessor being connected with an output end of the I2C module;
an angle measuring module, connected with the microprocessor;
a display module, connected with the microprocessor;
a power supply control module, one end of the power supply control module being connected with the microprocessor, the power supply control module having three output ends connected with the transmitting unit, the receiving unit, and the time measuring unit respectively; and
a button, connected with the microprocessor, an output end of the microprocessor being connected with the time measuring unit.

2. The laser rangefinder as claimed in claim 1, wherein the display module is a liquid crystal display.

3. A method for implementing the laser rangefinder as claimed in claim 1 or 2, comprising the following steps of:
a. the laser rangefinder being used to aim at an object to be measured, the button being pressed to start measuring;
b. the microprocessor responding to the key in real time, the power supply control module energizing the transmitting unit, the receiving unit and the time measuring unit;
c. the microprocessor sending a trigger signal to the time measuring unit;
d. the time measuring unit receiving the trigger signal and simultaneously sending a synchronous trigger signal through the gate signal module, the synchronous trigger signal controlling the laser emitting module to emit a laser beam, the synchronous trigger signal simultaneously triggering the counter unit to start counting;
e. the laser receiving module receiving the laser beam reflected by the measured object, the laser beam being amplified and shaped by the signal amplifying module and the shaping circuit module, an end pulse being fed back to the gate signal module of the time measuring unit, the gate signal module sending the end pulse to the counter unit for terminating the count immediately;
in the process, a start signal provided by the microprocessor being converted into a falling edge of the gate signal after synchronization, the end pulse after shaped by the receiving unit being converted into a rising edge of the gate signal to form a negative rectangular gate signal, a signal generated by an external high frequency crystal oscillator being performed for frequency multiplication and phase shift by the phase-locked loop module to generate a multiplex high frequency signal as a clock signal of the counter unit, upper and lower edges of the rectangular gate signal being measured by the independent pulse counters respectively; a rising edge of the end pulse being counted by an edge termination counter unit;
f. an integrated count result N of the counter unit being transmitted to the microprocessor through the I2C module;
g. the microprocessor receiving the integrated count result N of the counter unit, calculating a time value by the microprocessor, reading the information of an acceleration sensor in the angle measuring module, and ending a measurement;
the time being calculated by the microprocessor: time t=N*T0/8,
a distance between a ranging point and the measured object D=C*t=C*N*T0/8, T0=1/3*10-8 s, C=3*108 m/s, that is, D=N/8.
h. the steps c-g being repeated several times;
i. regression and iterative algorithm being used to integrate a number of measurement results and calculate the distance and an inclination angle between the ranging point and the measured object;
after the microprocessor sends the trigger signal, acceleration three-dimensional component data, Ax, Ay, and AZ, being read from the acceleration sensor of the angle measuring module, the microprocessor calculating the inclination angle of the distance between the ranging point and the measured object;
j. the results being displayed through the display module.

4. The method as claimed in claim 3, wherein in step e, the crystal oscillator has a frequency of 50M.

5. The method as claimed in claim 3, wherein in step j, there are four display modes;
mode 1, only displaying the distance in meters;
mode 2, only displaying the distance in yards;
mode 3, displaying the distance and the angle of inclination in meters;
mode 4, displaying the distance and the angle of inclination in yards.
